(19) United States
(12) Patent Application Publication
(10) Pub. No.: US 2011/0234415 A1
(43) Pub. Date: Sep. 29, 2011

(54) UNINTERRUPTIBLE POWER SUPPLY AND DETECTION DEVICE

(76) Inventors: CHING-NAN YANG, Yonghe City (TW); Tsung-Chih Kao, Yonghe City (TW); Chun-Hsin Yang, Yonghe City (TW)

(21) Appl. No.: 12/830,348

(22) Filed: Jul. 4, 2010

(30) Foreign Application Priority Data
Mar. 26, 2010 (TW) 099205313

(51) Int. Cl. G08B 21/00

(52) U.S. Cl. 340/635

(57) ABSTRACT

The uninterruptible power supply and detection device contains a power detection member and a power supply member, both connected to a house mains. The power detection member contains an AC (alternate current) transformer, a power detection unit, and a wireless transmitter. The power supply member is configured with an electronic device and contains a power supply unit, a wireless receiver, a driver unit, and a charger unit. The power detection member continues to transmit control signal to the power supply member within a coverage range as long as electricity is detected on the house mains. When the power detection member does not detect electricity and stops transmitting control signal, the power supply member switches the electronic device to receive electricity from the power supply unit so that electronic device could continue its operation.

### (a) TECHNICAL FIELD OF THE INVENTION

The present invention generally relates to uninterruptible power supplies, and more particular to an uninterruptible power supply and detection device that utilizes the original electrical wiring for backup power provisioning.

### (b) DESCRIPTION OF THE PRIOR ART

Existing emergency light devices are commonly hanged over exit doors and at corners of passageways of public places so that, during emergency and power outage, a certain level of lighting is provided to allow people to find their way. In recent years, people have increased concern over their residential safety and emergency light devices are more and more applied in households.

Existing emergency light devices have internal AC/DC (alternate/direct current) switches that allow a backup battery to be charged during normal hours, automatically stop the charging after the battery is full, and, when there is power outage, switch to draw electricity from the backup battery to turn on a lamp.

The lamp of the emergency light device is a separate one from the lamps already installed in the house, and the emergency light device usually requires the installation of a separate wiring. In other words, the existing lamps and electrical wiring of the house cannot be utilized. The use and installation of conventional emergency light devices is therefore not an economical approach. In addition, as the existing lighting structure cannot be utilized and the emergency light devices are hanged over doors and at corners, the internal decoration of the household is adversely affected.

### SUMMARY OF THE INVENTION

To obviate the foregoing shortcomings of prior arts, a novel uninterruptible power supply and detection device is provided herein, which contains a power detection member and a power supply member, both connected to a house mains. The power detection member contains an AC (alternate current) transformer, a power detection unit, and a wireless transmitter. The power supply member is configured with an electronic device and contains a power supply unit, a wireless receiver, a driver unit, and a charger unit. The power detection member continues to transmit control signal to the power supply member within a coverage range as long as electricity is detected on the house mains. When the power detection member does not detect electricity and stops transmitting control signal, the power supply member switches the electronic device to receive electricity from the power supply unit so that electronic device could continue its operation.

A major feature of the present invention is that existing electrical wiring is utilized to maintain uninterrupted operation of a large number of electronic devices during power outage.

Another major feature of the present invention is that, for emergency lighting application, existing lamps could be utilized and the internal decoration is intact. The present invention is therefore far more economical than prior arts.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a functional block diagram of an uninterruptible power supply and detection device according to the present invention.

FIG. 1A is a more detailed functional block diagram of the uninterruptible power supply and detection device of FIG. 1.

FIG. 2 is a flow diagram showing the operation scenario of the uninterruptible power supply and detection device of FIG. 1 when the presence of electricity is detected.

FIG. 3 is a flow diagram showing the operation scenario of the uninterruptible power supply and detection device of FIG. 1 when the presence of electricity is not detected.

FIG. 4 is a schematic diagram showing an embodiment of an uninterruptible power supply and detection device according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

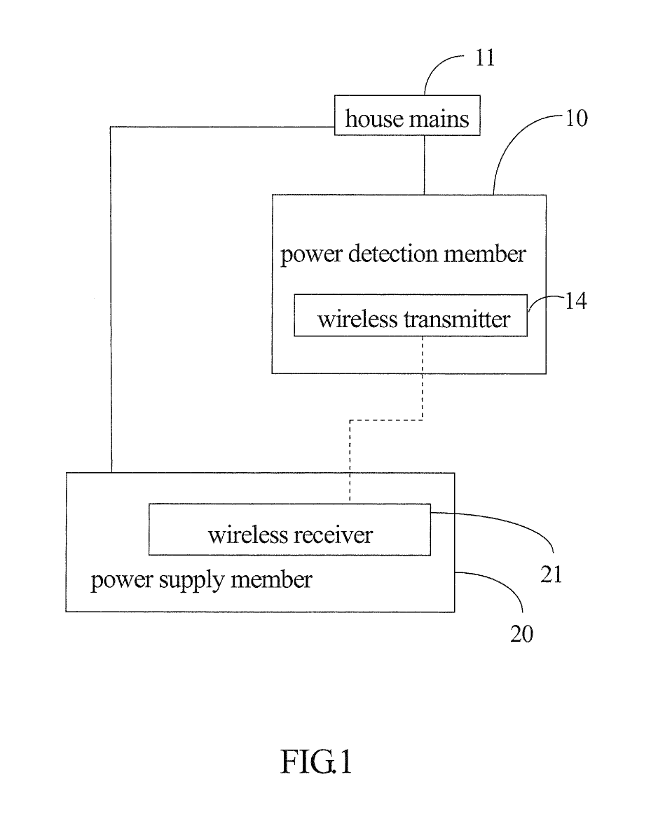

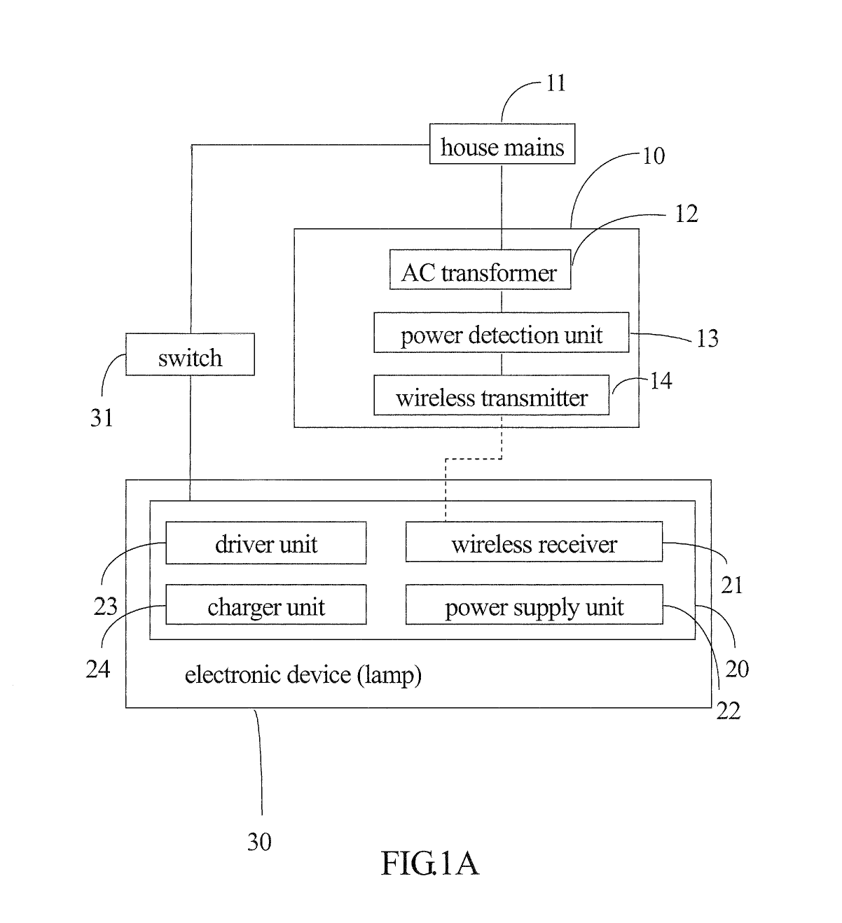

As shown in FIG. 1, the uninterruptible power supply and detection device according to the present invention contains a power detection member 10 having a wireless transmitter 14 and a power supply member 20 having a wireless receiver 21, both connected to a house mains 11.

The power detection member 10 detects the presence of electricity on the house mains 11 and transmits a corresponding control signal through the wireless transmitter 14.

The wireless receiver 21 receives the control signal and the power supply member 20 conducts different tasks in accordance with the control signal.

As shown in FIG. 1A, the power detection member 10 further contains an AC (alternate current) transformer 12 connecting the house mains 11, and a power detection unit 13 connecting the AC transformer and the wireless transmitter 14. The power detection unit 13 detects the presence of electricity on the house mains 11 through the AC transformer 12 and transmits a corresponding control signal through the wireless transmitter 14.

The power supply member 20 is configured with an electronic device 30 (e.g., a lamp) and further contains a driver unit 23 connected to the wireless receiver 21 and the house mains 11, a power supply unit 22 connected to the driver unit 23, and a charger unit 24 connected to the power supply unit 22 and the driver unit 23. The power supply unit 22 delivers internally stored electricity to the electronic device 30 through the driver unit 23. The charger unit 24 maintains the power supply unit 22 to have appropriate amount of internally stored electricity.

The electronic device 30 is connected to a switch 31 to control whether the electricity on the house mains 11 reaches the power supply member 20. Within the radio coverage of the wireless transmitter 14, there should be a wireless receiver 21 of at least one electronic device 30.

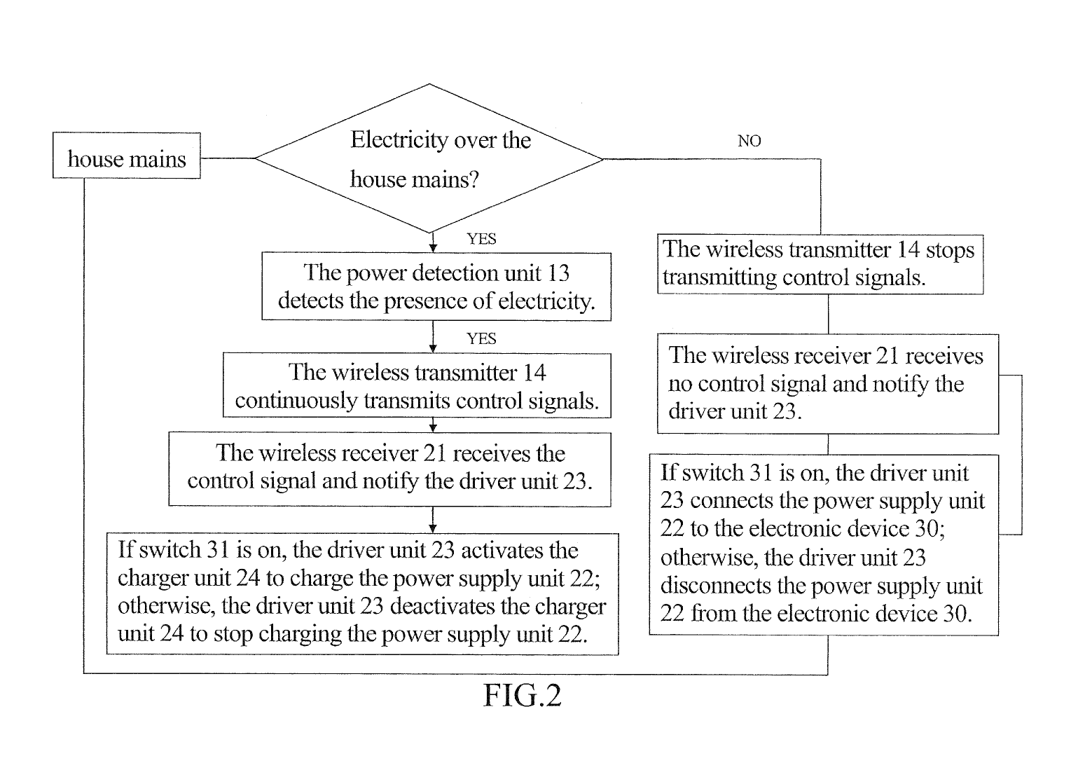

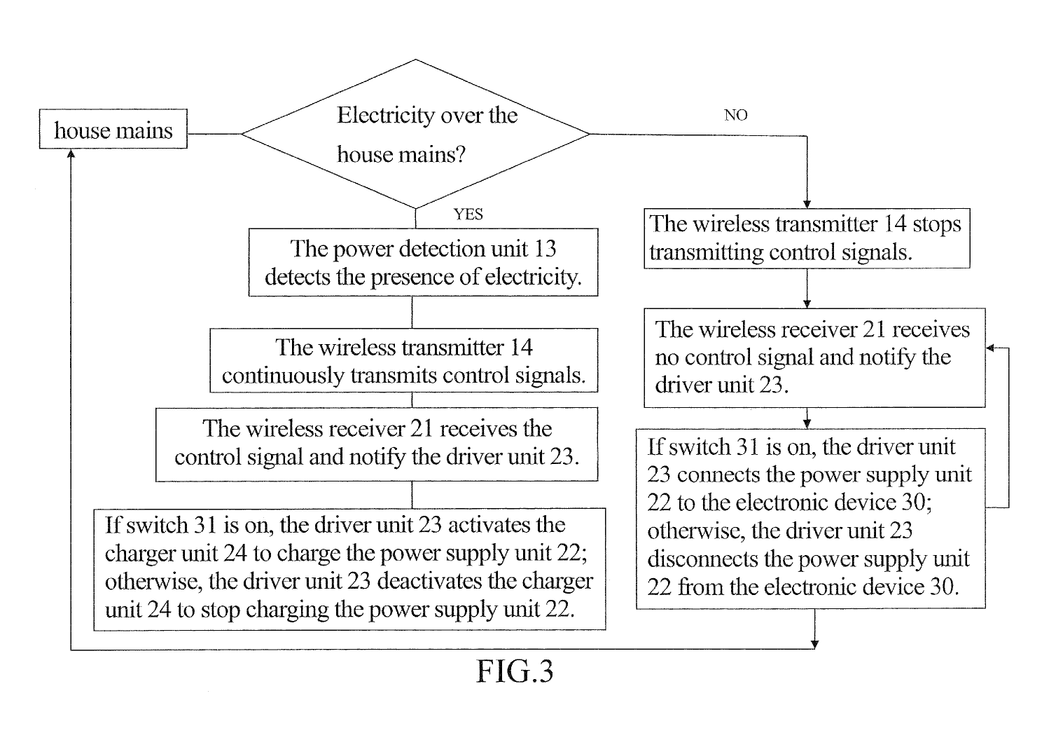

FIGS. 2 and 3 are flow diagrams showing the operation scenarios of the uninterruptible power supply and detection device of the present invention when the presence of electricity is and is not detected, respectively. As illustrated, the power detection unit 13 of the power detection member 10 detects the presence of electricity on the house mains 11 through the AC transformer 12. If the presence of electricity is detected, the wireless transmitter 14 under the control of the power detection unit 13 will continuously transmits control signal. Once the control signal is pick up by the wireless receiver 21, the driver unit 23 is notified of the reception of control signal. Then, depending on the condition of the switch 31, the driver unit 23 behaves differently. If the switch 31 is on (i.e., close-circuited), the electronic device 30 is powered by the house mains 11. In the mean time, the driver unit 23 activates the charger unit 24 to charge the power supply unit 22 so as to maintain an appropriate amount of internally stored electricity of the power supply unit 22. On the other hand, if the switch 31 is off (i.e., open-circuited), the electronic device 30 is of course not powered by the house mains 11. In the mean time, the driver unit 23 deactivates the charger unit 24 to stop charging the power supply unit 22.

If the presence of electricity is not detected, the wireless transmitter 14 under the control of the power detection unit 13 stops transmitting control signal. As no control signal is received by the wireless receiver 21, the driver unit 23 is notified of the missing of control signal. Then, depending on the condition of the switch 31, the driver unit 23 behaves differently. If the switch 31 is on (i.e., close-circuited), the driver unit 23 connects the power supply unit 22 to the electronic device 30 so that the electronic device 30 could continue operation by the internally stored electricity of the power supply unit 22. On the other hand, if the switch 31 is off (i.e., open-circuited), the driver unit 23 disconnects the power supply unit 22 from the electronic device 30. Please note that the power detection member 10 continuously monitors the house mains 11. Once the electricity on the house mains 11 is detected, the wireless transmitter 14 resumes transmitting the control signal. The rest of the scenario would be identical to what is described above.

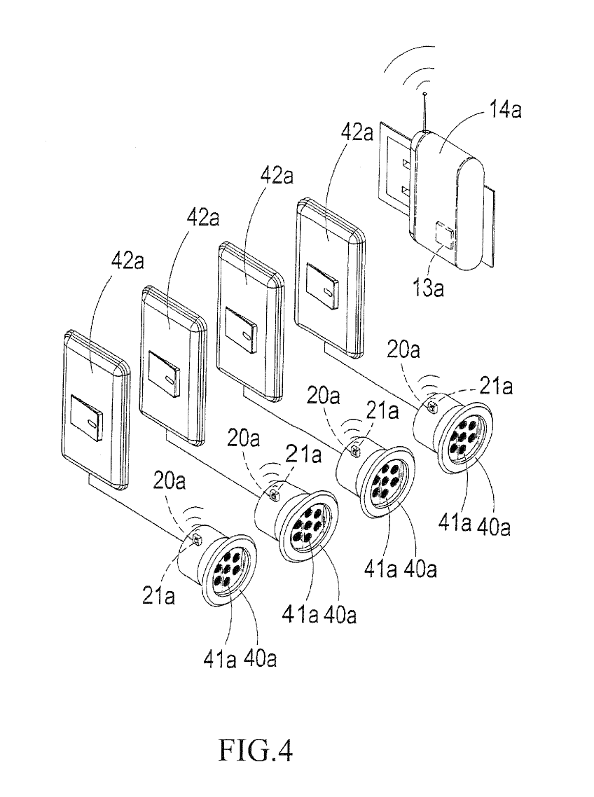

As shown in FIG. 4, an uninterruptible power supply and detection device according to an embodiment of the present invention contains a power detection member and a number of power supply members 20a within the radio coverage of the power detection member. The power detection member having a wireless transmitter 14a and a power detection unit 13a is plugged into a mains socket. Each power supply member 20a is configured with an electronic device 40a (e.g., an appliance requiring uninterruptible power supply or a lamp having a light generating element 41a such as light emitting diode, cold or hot cathode ray tube, gas discharge lamp, or halogen lamp, etc.) and is connected to a switch 42a. Each power supply member 20a has a wireless receiver 21a to capture the control signal from the wireless transmitter 14a. A driver unit (not shown) inside each power supply unit 20a then operates in accordance with the foregoing description.

As described, the present invention could be installed on an existing electrical wiring and works with any electronic device 40a capable of connecting to the existing wiring. When the electronic device 40a is a lamp, an emergency lighting device is achieved without installing a separate lamp and without ruining the internal decoration. Further, according to the requirement, any electronic device 40a with the power supply member 20a could be replaced at will and more could be added. Also, as all wireless receivers 20a within the coverage of the wireless transmitter 14a could receive the control signal, the stability of the uninterrupted operation of the electronic devices 40a could be ensured.

Therefore, compared to prior arts, the present invention has the following advantages: (1) existing power provision system is maintained and utilized; (2) existing electrical wiring is maintained and utilized; and (3) basically unlimited number of electronic devices could be configured to run uninterruptedly during power outage.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An uninterruptible power supply and detection device, comprising
a power detection member having a wireless transmitter; and
a power supply member having a wireless receiver receiving a control signal from said wireless transmitter;
wherein both said power detection and supply members are connected to a mains.

2. The uninterruptible power supply and detection device according to claim 1, wherein said power detection member further contains an AC (alternate current) transformer and a power detection unit; said AC transformer is connected with said mains; said power detection unit is connected to said AC transformer and said wireless transmitter; and said power detection unit continuously detects the presence of electricity over said mains through said AC transformer, and control said wireless transmitter to transmit said control signal.

3. The uninterruptible power supply and detection device according to claim 1, wherein said power supply member further contains a driver unit connected to said mains and said wireless receiver, a charger unit connected to said driver unit, a power supply unit connected to said charger unit and said driver unit; when said control signal is received, said wireless receiver notifies said driver unit and said driver unit instructs said driver unit to charge said power supply unit; and, when said control signal is not received, said wireless receiver notifies said driver unit and said driver unit connects said power supply unit to said mains so that internally stored electricity of said power supply unit is delivered to said mains.

4. The uninterruptible power supply and detection device according to claim 1, wherein said wireless receiver is within a coverage range of said wireless transmitter.

5. An uninterruptible power supply and detection device for an electronic device, comprising
a power detection member having a wireless transmitter; and
a power supply member having a wireless receiver receiving a control signal from said wireless transmitter;
wherein said power supply unit is configured with said electronic device; and both said power detection and supply members are connected to a mains.

6. The uninterruptible power supply and detection device according to claim 5, wherein said electronic device is a lamp or an appliance requiring uninterrupted power supply.

7. The uninterruptible power supply and detection device according to claim 5, wherein said electronic device is connected to a switch to control whether the electricity on said mains reaches said power supply member.

8. The uninterruptible power supply and detection device according to claim 5, wherein said wireless receiver is within a coverage range of said wireless transmitter.

9. The uninterruptible power supply and detection device according to claim 5, wherein said electronic device is configured with a light generating element.

10. The uninterruptible power supply and detection device according to claim 6, wherein said electronic device is configured with a light generating element.
